(19) United States
(12) Patent Application Publication
(10) Pub. No.: US 2025/0163298 A1
(43) Pub. Date: May 22, 2025

(54) COMPOSITE MATERIAL, METHOD OF PRODUCTION AND METHOD FOR THE ENERGY-EFFICIENT SEPARATION OF THE COMPOSITE

(71) Applicant: Josef Andreas HROVATH, Riegersdorf (AT)

(72) Inventor: Josef Andreas HROVATH, Riegersdorf (AT)

(21) Appl. No.: 18/723,439

(22) PCT Filed: Dec. 23, 2021
(86) PCT No.: PCT/EP2021/087544

§ 371 Date: Jun. 23, 2024

(51) Int. Cl. C09J 5/06; B32B 7/06; B32B 7/12; B32B 9/00; B32B 9/04; B32B 15/04; B32B 15/20; B32B 17/06; B32B 27/06; B32B 43/00; C09J 163/00

(52) U.S. Cl. CPC C09J 5/06; B32B 7/06; B32B 7/12; B32B 9/002; B32B 9/005; B32B 9/04; B32B 15/04; B32B 15/20; B32B 17/06; B32B 27/06; B32B 43/006; C09J 163/00; B32B 2307/748; C09J 2400/126; C09J 2400/146; C09J 2400/166; C09J 2463/00

(57) ABSTRACT

Composite materials that are especially recyclable, the composite materials having at least two material layers bonded by a layer of adhesive. For an easy and clean separation of the two material layers the adhesive consists of a material that loses its adhesive effect when introduced into a weakly acidic solution.

### TECHNICAL FIELD

The present disclosure relates to composite materials. More particularly, the present disclosure relates to a sandwich composite material, a method for its production and for energy-efficient separation of the composite.

### BACKGROUND

In sandwich construction, materials with different properties are assembled in layers to form a part or semi-finished product. The sequence of top layer-core-top layer is typical, but not mandatory. The resulting sandwich parts are now used in many areas of industry, especially when it comes to combining lightweight construction with excellent mechanical properties. These include, for example, sports equipment, components for vehicles, trains and other means of transport, or building materials.

In sandwich construction, the core and the cover layer are usually permanently connected to each other, especially if the core consists of thermoset polymers and foams that are only crosslinked or foamed during the manufacturing process, such as rigid polyurethane (PU) foam, rigid polystyrene (PS) foam, expanded polystyrene (EPS) rigid foam, or particle foams made from EPS, expanded polyethylene (EPE) and expanded polypropylene (EPP). Particularly when producing sandwich structures based on thermoset polymers (resins) and/or foams, it is not possible to separate the materials from each other after use or failure of the part/semi-finished product without high heat input or aggressive chemicals (e.g. strong acids and alkalis).

There are already special water-soluble (recyclable) epoxy resin systems for sandwich composite materials, especially fiber-reinforced composites made of glass fibers, carbon fibers, natural fibers, etc., which allow the components of the sandwich composite to be separated under relatively mild conditions (slightly acidic environment) by dissolving the resin system (EP2646410B1, DE19733643A1), but the applications are currently mostly limited to fiber-reinforced laminates in which the recyclable epoxy resin is easily accessible to the solvent. Only the fibers are detached from the matrix in this process. According to the current state of the art, the adhesive layer is not used as a separable intermediate layer (separating layer) in sandwich composite part, especially in the composition of foam and cover layer, because if the consolidation between the core and cover layer is too strong (e.g. in the case of expanding reactive foams), the solvent cannot penetrate deeply enough into the separating layer, which means that the latter cannot be dissolved and no separation can take place. A possible solution is the use of appropriate recyclable resins mixed with thermally decomposable substances, such as hollow microspheres (EP 1 111 020 A2, DE102009019484A1). The problem here is that additional energy in the form of heat must be introduced for separation. In most cases this means temperatures of over 100° C., which has a negative impact both on the environmental balance and possibly also the material properties as well.

In addition, the examples presented in the relevant disclosures only contain adhesion promoter variants based on fossil and non-renewable raw materials, which further limits the eco-friendliness of the material combinations. With the variants set out in EP 1 111 020 A2, which refer to one- or two-component polyepoxides with water vapor-generating, thermally activated substances which are dispersed in the binder in amounts between 1 and 20% by weight, in some cases not enough water vapor can be produced to separate layers that have been joined under high pressure.

Given this state of the art, it is currently not possible to separate two materials, in particular sandwich composite parts, such as panels made of a pressure-resistant thermoset fiber-reinforced cover layer and a thermoset or thermoplastic foam core and/or another core construction (honeycomb, lattice or foam structure) made from natural materials such as wood, bamboo, flax, etc. or made from synthetic and/or bio-based polymers such as EPS, PLA, PP, PHBS, which is connected to a top layer by thermoset polymers, with low energy consumption (without external energy supply and without aggressive chemicals, time-efficiently into their single-variety components (GB2513834A, U.S. Pat. No. 8,776,698B2, U.S. Pat. No. 8,808,833B2). This includes not only two-dimensional panels, but also three-dimensional parts structures created using shaping processes such as pressing tools. The lack of or disadvantages of options for separating the parts into their components impair or completely prevent the recycling of such material connections and the corresponding composite material parts, which has a negative impact on their environmental balance.

The content of the publications mentioned is incorporated by reference into the content of this description for those jurisdictions in which this is possible.

The following items are known in the prior art:
Water-soluble adhesives based on epoxy with thermally decomposable substances in shares of 1-20% by weight, which release water vapor when heated, or hollow microspheres (EP 1 111 020 A2, DE102009019484A1)
Separation process for fiber composite laminates with recyclable epoxy under mild conditions or redissolvable adhesion promoters of other types (EP2646410B1, DE19733643A1)
Process for producing sandwich composite panels with a foam core or honeycomb core and various cover layers (GB2513834A, U.S. Pat. No. 8,776,698B2, U.S. Pat. No. 8,808,833B2)
Parts and semi-finished products made of composite materials in sandwich construction (wall/floor elements, board sports items, insulating elements, floor coverings, reinforcing elements) that cannot currently be recycled because the materials used cannot be separated cleanly from one another-especially in the combination core made of PU rigid foam

The problem to be solved by the present disclosure is that of avoiding the disadvantages mentioned above and achieving the advantages mentioned.

### SUMMARY

The present disclosure is directed to composite materials that may be readily recycled, and methods of releasing the adhesives used in such composite materials.

In some examples, the disclosure includes composite materials having at least two layers of material connected to one another by a layer of adhesive, where the adhesive includes a material that loses its adhesive effect when that material is placed in a weakly acidic aqueous solution.

In some examples, the disclosure includes methods for releasing a bond of a composite material, where the composite material includes at least two layers of material connected to one another by a layer of an adhesive material that loses its adhesive effect when the adhesive material is placed in a weakly acidic aqueous solution; where the method includes preparing a weakly acidic aqueous ethyl acetate solution, and holding the composite material in the weakly acidic aqueous ethyl acetate solution for 12-48 hours.

### BRIEF DESCRIPTION OF THE DRAWINGS

FIG. 1 schematically depicts an exemplary composite material having a sandwich structure according the present disclosure.

FIG. 2 schematically depicts an exemplary composite material having a combination of two different materials according to the present disclosure.

FIG. 3 schematically depicts an exemplary composite material having a combination of two identical materials according to the present disclosure.

FIG. 4 schematically depicts an exemplary composite material that is a 3-dimensionally curved sandwich variant, according to the present disclosure.

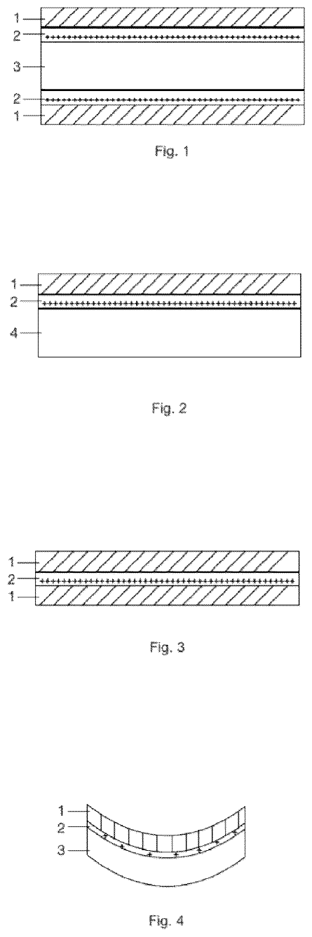

### DETAILED DESCRIPTION

The present disclosure provides composite materials that avoid the disadvantages mentioned above, and achieve the desired advantages. The disclosed composite materials include a separating layer or intermediate layer (adhesive layer) between the connection of two materials, such as a cover layer and a core (or a second cover layer, generally a layer one and a layer two), the adhesive strength of which is destroyed or at least largely reduced by placing it in a mildly acidic solution without heating.

In one embodiment, it is possible to completely remove this separating or intermediate layer from the component within less than 24 hours without the use of dangerous and aggressive chemicals or heat by storing it for a maximum of 24 hours in a mildly acidic aqueous solution (e.g. 5-25% aqueous ethyl acetate). solution) so that all components except for the separating layer can be recycled or reused as single-variety products. This is made possible by using to crosslink the (poly) epoxides of the adhesive layer special hardener components which are based on diamine acetal and diamine ketal derivatives and can be dissolved in a mildly acidic aqueous solution at room temperature.

In a further embodiment, hardener components based on thermolabile polyimine compositions that can be redissolved in the aqueous ethyl acetate solution or in ethanol with the addition of 30-50% by volume of triethylenetetramine can be used to crosslink the (poly) epoxides of the adhesive layer. Adhesive layers produced in this way lose their adhesive properties even without the addition of triethylenetetramine simply by heating to over 80° C. The special properties are based on rearrangements of the chemical bonds in the polymer network using catalyzed transesterification, thereby causing a change in the number of bonds within the network.

Finally, in a further embodiment, the share of regenerative (bio-based) raw materials in the adhesive layer is, according to the present disclosure, at least 24% by weight. For this purpose, BPA or glycerol-based (poly) epoxides are used, which contain a share of carbon from renewable sources in the molecular structure that can be determined according to ASTM D6866. The shares of carbon from renewable sources can be:
epoxidized vegetable oils, such as soybean oil, castor oil, linseed oil, cashew nut shell oil
epoxidized sorbitol and glycerol derivatives
Lignin, tannin or cellulose derivatives

The materials used, the various heating options and the details of the separation process are described in detail below.

The present disclosure thus provides a method for producing single-variety recyclable, eco-friendly composites of several but at least two materials, in particular sandwich composite materials made of at least one cover layer and one core material. The disclosure also provides the associated separation process for the components of the sandwich composite materials produced in this way. At the end of their life cycle, these can be completely separated without aggressive chemicals, without external heat and without the use of high temperatures, so that the materials used can be reused or recycled after less than 24 hours. Particularly for parts that consist of a cover layer and a PU core material, whose recyclability is currently severely limited, the present disclosure allows the production of more eco-friendly variants, which, for example in the construction industry, can make a significant contribution to improving the sustainability of the entire construction sector. One of the variants listed allows the production of single-variety recyclable sandwich parts/semi-finished products made of rigid PU foam and a natural fiber top layer with a share of renewable (bio-based) resources of up to 70%.

The present disclosure also provides sandwich parts produced from a core made from PU rigid foam (partly based on regenerative raw materials), from a polymeric lattice structure (in particular additively manufactured from ABS, PLA, PP, PET and their composites) or from wood-based materials and at least one cover layer made of ceramic materials, natural stone-based materials, wood and wood veneer, or (natural) fiber-reinforced thermoset composites.

### Summary of Benefits Generated

Eco-friendliness through increasing the share of renewable resources and improving recyclability through improved purification of the components
Creating opportunities for recyclable product design
Production of recyclable sandwich components from and with various rigid foam or particle foam core variants made from PU, EPS, PP, EPE, PS, EPP, PLA, EPLA
Economic efficiency (faster process of separating materials from one another)
Ecological efficiency (less material and lower toxicity of the components as well as the materials required for separation)

### Application Areas

Construction industry: Insulating elements, floor coverings, wherever rigid polyurethane foam and the other rigid foam and particle foam core variants mentioned in the text, which are stiffened/protected by a top layer, are used.
Sandwich panels for floor and wall elements
Board sports items: skis, snowboards, surfboards, skateboards, kiteboards, stand-up paddleboards [SUPs], etc.
Reinforcing elements for surfaces and covering layers made of natural stone, ceramics, veneer, etc.

Material examples for the composite materials and structures thereof:
The composite materials mentioned either have a classic sandwich structure consisting of a core and at least one cover layer, but can also be a combination of two different materials with different properties, such as a brittle surface (ceramic, natural stone, concrete, etc.) and a ductile material (e.g. woven fabrics and crossply laminates). A structure is also possible that connects two identical materials to one another via a redissolvable separating layer, and these can then be separated.

The composite materials of the present disclosure may be better understood with reference to the drawings, where the reference numbers stand for:
1 body made of a first material
2 adhesive layer
3 core
4 body made of a second material

The dots and lines shown in the adhesive layer indicate that reinforcement in the form of fibers, a fleece and the like and/or an additive in the form of a conductive substance can optionally be provided.

It should also be noted that in the description and claims the adhesive layer is also referred to synonymously as a separating layer or separation plane (because it not only connects the other two layers, but also separates them).

The composite materials can either be produced in two-dimensional plate, beam or cuboid form or can result in any three-dimensional structures using shaping processes (pressing technology) (FIG. 4).

The cover layers and materials to be connected can have any thickness, preferably in the range from 0.1 mm to 100 mm, and can consist of the following materials or material classes:
Wood: wooden panels, wooden boards, wood veneer, wood fabric, wood scrim, wood composites
Glass: glass pane, glass composites, glass plates
Ceramics: ceramic tiles, ceramic plates, ceramic composites
Natural stone: natural stone slabs, natural stone composites, natural stone tiles
Polymers (thermoplastic/duroplastic): PP, PET, PLA, PA, PU, ABS, polyester, epoxy, etc., fiber-filled polymers, polymer sheets, polymer films, polymer layers, roll goods.
Fiber fabrics/wovens and composites made from them: carbon fibers, natural fibers (flax, hemp, bamboo, kenaf, etc.), glass fiber, aramid fibers, basalt fibers
Metals: Aluminum

The cores and core components contain at least one material, but can also consist of different material classes. They can also come in any thickness, preferably in the range from 1 mm to 300 mm. The cores can be foamed (open cell, closed cell, particle foam), 3D printed (lattice or closed structure), or extruded (plate shape, honeycomb structure, etc.) and consist of the following materials:
Polymers of any kind, especially Rigid foams made from thermoset reactive resin systems such as PU or epoxies and from thermoplastic polymers such as EPS, EPE, EPP, PLA and others.
Fiber-filled composites made from the above-mentioned polymers
Wood and wood-based materials, such as WPC (wood-plastic composites)
Metal and metal-based materials, such as aluminum foams or lattice structures.
Recycled materials, especially made of plastic, such as rPET foams or rPET honeycomb cores

More detailed description (production and separation of recyclable sandwich composite materials)

The present disclosure includes a method for producing recyclable sandwich composite structures, as well as separating them into individual components that can either be reused or completely recycled. The present disclosure also includes the parts resulting from the manufacturing process. The disclosure refers specifically to sandwich structures made of a PU foam core and a ceramic cover layer, but can be applied to any combination of materials mentioned in the “material examples”.

### Novelty, Effects

Manufacture of parts/semi-finished products made from composite materials in sandwich construction, which can be separated from each other more efficiently (non-toxic, less energy required, shorter time) and more cleanly due to the process presented. This creates more eco-friendly versions of the products mentioned above, which also allow circular economy applications and business models (wall/floor elements, board sports items, insulating elements, floor coverings, reinforcing elements, surfaces).
Based on the above-mentioned facts, the following improvements result: Compared to EP 1 111 020 A2 and DE102009019484A1: more eco-friendly, due to the use of renewable raw materials and simplified cleaning of the parts; no heat is required for separation (only acidic aqueous solution); compared to EP2646410B1 and DE19733643A1: Process extended to use in sandwich construction, especially for foam core and top layer structures, compared to GB2513834A, U.S. Pat. No. 8,776,698B2, U.S. Pat. No. 8,808,833B2: recyclability

This results in the following special features of the present disclosure and its different forms and further developments:
1. At the product/part level: Completely recyclable parts made of a rigid foam based on PU, epoxy, EPS, EPE, EPP, PLA or particle foam based on EPS, EPE, EPP, PLA and cover layers made of various materials including eco-friendly separation processes for the components, enabling single-variety recycling. The parts design can be transferred to applications and products in the areas of walls, floors, skis, snowboards, surfboards, etc., which leads to a measurable improvement in the CO₂-balance through an increased recycling rate
2. At the technology level: new separation method for composite materials from core and cover layer, wherein core and cover layers can be specified in detail
3. At the material level (soluble adhesion promoters, adhesive layer): new special combination of bio-based epoxy resin systems with a new class of acid-labile hardener components based on diamine ketal and/or acetal and thermally labile hardener components based on polyimine derivatives. With additional thermally activatable additives, separating layers can be produced for all possible composite systems, which can be removed from the part in an eco-friendly and easy way without leaving any residue.

Further details about the disclosed composite materials:

A separating plane (separating layer) is created between the two different materials or the cover layer and the core, which can be specifically dissolved. This separating layer consists of an acid-labile bio-based thermoset matrix with a specific brittleness of 7H to 9H determined by measuring the degree of pencil hardness according to ASTM D 3363). For this purpose, a mixture of a bio-based, acid-labile resin system with a share of 20-99% regenerative (renewable) raw materials (=bio-resin) is applied as a layer at least 2 mm thick to the surface of the cover layer facing the core (e.g. ceramic surface). After the mixture has hardened, the cover layer can be used as usual in the respective manufacturing process (e.g. foaming in a pressing tool). The same applies for the joining of two identical or different material layers. The bio-resin is also applied to the surface of a layer of material facing the adhesive surface and, when hardened, is joined to the second layer of material.

The components of the composite part are separated by storing the component for a maximum of 24 hours in a mildly acidic aqueous solution (e.g. 5-25% aqueous ethyl acetate solution). The properties of the parts are not affected and the parts can be easily freed from the adhesive layer and cleaned. Depending on the type of components, they can then either be reused, recycled as the single materials or composted. In all variants of the adhesive layer, the separation takes place by placing the parts in a weakly acidic ethyl acetate solution or an acidic imine or triethylenetriamine solution, completely without external heat.

The present disclosure also relates to adhesion promoter compositions based on epoxy resins (acid-labile, from renewable resources and without BPA) and so-called diamine or polyimine hardeners or water-based polyacrylate resins, which can also be conductive or be made conductive by adding conductive substances.

According to ASTM D6866, the share of renewable raw materials in the resin system is determined by the share of carbon from renewable sources in the molecular structure of the resin system and is at least 20%. A particularly eco-friendly variant is based on formulations without the carcinogenic bisphenol A (BPA) and a share of renewable raw materials of more than 70%. The systems are particularly characterized by the fact that, due to the selection of special diamine and polyimine hardeners, the resin can be dissolved under very mild conditions (acetic acid, addition of the imine monomer or tetraethylenetriamine). This means that the interconnected components of the parts or products can be easily cleaned of resin residues and either reused or recycled as single materials.

Another possibility for producing the recyclable sandwich composite materials is by applying one or more layers of thin films (or foils) made of a water-soluble polymer (e.g. polyvinyl alcohol), which can be glued to the substrates using the bio-resin systems mentioned. This means that the penetration of the solvent (mildly acidic aqueous solution) is simplified or the solvent can be omitted completely. This leads to a particularly resource-saving variant of the separation process, which involves simply placing the parts in a purely aqueous solution. The additional layer of water-soluble polymer film dissolves very easily in water even at room temperature. The parts can then be freed from the adhesive layer in an acidic solution after 24 hours without leaving any residue. One disadvantage of this variant is the sensitivity of the water-soluble polymers to environments with high humidity.

The composite parts that were joined using this method and can be separated using the methods described are also part of this disclosure. The composite parts can be:
Floor panels, wall elements, roof elements, doors
Door and other panels in the automotive sector
Interior and exterior cladding elements for leisure, rail and transport vehicles
Board sports items such as skis, snowboards, surfboards, kiteboards, skateboards, etc.
Surfaces made of ceramic and natural stone that are reinforced with fiber fabrics and/or foams

### APPLICATION EXAMPLES

In the description, especially in the examples, the adhesive or the layer of adhesive is also called “adhesive agent” or “separation layer,” but it always means the material that connects the two layers to each other (separably).

Example 1: Production of a recyclable floor element made of partially bio-based PU rigid foam and a cover layer made of ceramic, glass, natural stone such as granite or basalt, or a combination of these cover layers.

Separating layer: BPA-free, glycerol-based 2K bio-epoxy resin with an acid-labile recyclable hardener.

### BRIEF DESCRIPTION

A surface made of ceramic, glass, natural stone such as granite or basalt, or a combination of these material classes is coated with a mixture of glycerol-based reactive 2K bio-epoxy resin and recyclable hardener in several layers (at least 3 mm thick). Modification: To improve the separation effect, one or more layers of thin films made of a water-soluble polymer (e.g. polyvinyl alcohol) can be glued to the surface using the same bio-resin mixture. This means that the separation can be done with only an aqueous solution, which represents a particularly resource-saving variant of the separation process.

The ceramic modified in this way is then combined with a PU foam (back-foamed), whereby the PU foam ensures adhesion to the ceramic. The separation is carried out by placing the parts in a mildly acidic ethyl acetate solution.

### DETAILED DESCRIPTION

100 g of a BPA-free epoxy resin, for example the company R*Concept (trade name Plankton) made of a Glycerol-based Polyol MF (C₁₂H₂₀O₆), a 3-aminomethyl-3,5,5-tyrimethyl-cyclohexyl-amine and a cyclohexane-carbonitrile-5-amino-1,3,3-trimethyl with a share of >90% of renewable raw materials is mixed with 36 g of an acid-labile curing agent consisting a of diaminoacetal (mixture of 2,2-bis(aminoethoxy) propane, 2-aminoethanol and ethanolamines) at room temperature. The adhesion promoter mixture is then applied to the surface of the top layer, for example a ceramic plate made of alumina, feldspar, aluminum and silicon carbide or a surface made of glass, natural stone such as granite or basalt, or a combination of these material classes, and cured for at least 60 minutes at room temperature. This process is repeated several times until a separating layer with a minimum thickness of 3 mm is created. Alternatively, one or more layers of water-soluble film can also be glued onto the layer in order to achieve a slightly modified separation mechanism or to increase the effectiveness of the dissolution of the separation layer.

After 24 hours, the treated cover layer is placed in a hot-pressing system and back-foamed with a reactive polyurethane foam and joined with the other components required to produce a floor element. In this case, the reactive foam can consist of a polyol mixture which contains an alkylaminocarboxamide, an alkoxylated alkylamine, a benzyldimethylamine and an N,N-dimethylcyclohexylamine in different relative concentrations. Likewise, other additives (such as common catalysts, blowing agents, stabilizers, etc.) can be incorporated into the polyol mixture to modify the reactivity and mechanical properties. For foaming, the polyol components are combined with a diphenylmethane diisocyanate consisting of isomers and homologues. After the foaming process, the finished composite part is assembled and cured for a further 24 hours at room temperature.

A particularly sustainable variant for the composite part is created by using a polyol mixture based on renewable raw materials, so-called bio-based polyols. Such polyols usually contain a proportion of 10% to over 90% of renewable raw materials (e.g. from so-called Cashew Nutshell Liquids—CNSLs). As a concrete example, formulations of such a cashew nut shell polyol mixture consisting of a CNSL Mannich polyol with water and Ecomate as a blowing agent and a DABCO catalyst in a mixing ratio of 1:1 with a diphenylmethane diisocyanate consisting of isomers and homologues can be mentioned. With this approach it is possible to increase the share of renewable raw materials in the PU foam core to over 40%. Examples of possible mixing ratios for the polyol with water and Ecomate as blowing agent are given in Table 1 overleaf:

To reuse the top layer, the entire floor element is placed in an acid bath (15-25% ethyl acetate), which completely removes the adhesive layer from both the surface and the foam. The top layer can be reused without further steps in the production process and the foam can be recycled as single materials after the remaining components of the floor system have been removed. The ethyl acetate solution can be reused for another separation process. If used several times, the dissolved adhesion promoter collects in the solution and can be extracted as a thermoplastic after the solution has been neutralized.

TABLE 1

| | CNSL polyol | PU | Water | Ecomate | DABCO |
|---|---|---|---|---|---|
| No | [g] | [g] | [mL] | [g] | [mL] |
| 1 | 20 | 20 | 0.5 | 5 | |
| 2 | 20 | 20 | 0.5 | | |
| 3 | 10 | 10 | | 2 | |
| 4 | 10 | 10 | | | 0.5 |
| 5 | 10 | 10 | 0.5 | | 0.2 |
| 6 | 10 | 10 | | 2 | 1 |
| 7 | 10 | 10 | | 2 | 2 |
| 8 | 10 | 10 | 1 | | 1 |
| 9 | 10 | 10 | 2 | | 1 |
| 10 | 12 | 16 | 1 | | 1.5 |
| 11 | 12 | 17 | 1 | | 1 |
| 12 | 10 | 12 | 1 | | 1 |
| 13 | 10 | 12 | 2 | | 1 |
| 14 | 10 | 12 | 1 | | 2 |
| 15 | 10 | 12 | 2 | | 2 |
| 16 | 10 | 12 | 1 | | |
| 17 | 10 | 12 | 3 | | |

If one or more layers of thin films made of a water-soluble polymer (e.g. polyvinyl alcohol) were also glued to the adhesion promoter layer to improve the separation effect, it is sufficient if the parts are simply placed in a purely aqueous solution, which represents a particularly resource-sparing variant of the separation process. Specifically, the additional layer of water-soluble polymer film dissolves very easily in water even at room temperature.

Example 2: Production of a recyclable PUR insulating panel with a structural (decorative) top layer for use as a facade element

Separating layer: BPA-free, glycerol-based 2K bio-epoxy resin with an acid-labile recyclable hardener.

### BRIEF DESCRIPTION

A PUR foam core is coated on the surface several times with a mixture of glycerol-based reactive 2K bio-epoxy resin and recyclable hardener (layer thickness at least 3 mm). The “last” layer also provides adhesion to the structural surface layer, such as a thin steel or aluminum sheet, a surface of natural stone or ceramic, a ready-made fiber-reinforced duroplastic laminate, etc. The foam core is glued to the corresponding cover layer. The surface material primarily serves to stiffen, stabilize and protect the foam material, but can also have a decorative function. Such a PUR insulating panel can therefore also serve as a functional facade element. After use of the plate, the surface can be separated from the foam core by heating and the subsequent release of water of crystallization in the separation plane.

### DETAILED DESCRIPTION

100 g of a BPA-free epoxy resin made of a glycerol-based Polyol MF (C₁₂H₂₀O₆), a 3-aminomethyl-3,5,5-trimethyl-cyclohexyl-amine and a cyclohexane-carbonitrile-5-amino-1,3,3-trimethyl containing >90% of renewable raw materials are mixed with 36 g of an acid-labile curing agent comprising a diaminoacetal (mixture of 2,2-bis(aminoethoxy) propane, 2-aminoethanol and ethanolamines) at room temperature. The adhesion promoter mixture is then applied to the surface of a PUR foam board of any size in several layers, whereby each of these layers is cured for at least 60 minutes before the next one is applied (min. layer thickness: 3 mm). The last layer is then connected to the corresponding structural top layer (sheet metal, laminate, board) before it is crosslinked and is responsible for providing adhesion to this top layer. The element prepared in this way is then cured for 24 hours at room temperature.

To reuse the top layer, the entire element is placed in an acid bath (15-25% ethyl acetate), which completely removes the adhesive layer from both the surface and the foam. The top layer can be reused without any further steps and the foam core can be recycled as a single material. The ethyl acetate solution can be reused for another separation process. If used several times, the dissolved adhesion promoter collects in the solution and can be extracted as a thermoplastic after the solution has been neutralized.

Example 3: Production of a recyclable fiber-reinforced thermoformable cover layer for manufacturing the upper and/or lower girt in board sports equipment such as skis, snowboards, skateboards or surfboards.

Separating layer: BPA-based bio-epoxy resin component and thermolabile polyimine hardener component

### BRIEF DESCRIPTION

A natural fiber scrim or fabric made from flax, hemp, bamboo, kenaf, etc. is impregnated with a mixture of bio-epoxy resin components, thermolabile polyimine hardener and then cured. This creates a so-called prepreg which, with the correct selection of the polyimine hardener, is stable at room temperature and can be shaped as desired in the temperature range of 70 to 80° C. In this temperature range, the prepreg also develops an adhesive effect to other materials and can be applied as a top layer, upper/lower girt in the production of board sports equipment. The cover layer created in this way is break-resistant due to the fiber reinforcement and, thanks to the thermoset crosslinking of the matrix, can serve as a break-resistant surface for various applications by being glued to other carrier materials (substrates). After use, the surface can be separated from the substrate by heating to over 80° C. The special bio-resin mixture with polyimine hardener allows the resin system to be completely dissolved by adding an excess of the corresponding imine monomer (30-50% by volume in ethanol or ethyl acetate).

### DETAILED DESCRIPTION

200 g of a polyimine hardener consisting of an imine mixture of protected composition, a diethylene triamine and a 4,4′-diamino-dicyclohexylmethane are heated to 90° C. while stirring using a heating stirrer or an infrared lamp or an electromagnetic induction loop. In addition, 2-10% by weight of a solvent from the group butanone, xylene or isopropyl alcohol may be added to reduce the viscosity, but is not necessary. For this purpose, 100 g of an eco-friendly epoxy resin based on bis-[4-(2,3-epoxipropoxi)phenyl]propane is added with a >20% share of renewable raw materials and this mixture is stirred at a temperature of 60° C. for a further 5 minutes. The finished mixture is applied to a natural fiber scrim or fabric made from flax or hemp at 40° C. The prepreg produced in this way is then cured for 24 hours at room temperature and then, after reheating to over 80° C. or before curing in the non-crosslinked state, pressed with an appropriate substrate, such as a surfboard or ski core, as a top layer and then cured at room temperature for at least 24 hours. To separate the layers, the part is heated to 80° C.-90° C. for at least 3 minutes until the separation layer begins to “flow.” In this state, the cover layer can be easily removed from the corresponding substrate and either reused in the same state or dissolved by placing it in an aqueous ethyl acetate solution with a share of 1-50% of the corresponding imine monomer or triethylenetetramine (TETA) in the building blocks of the adhesion promoter, which after processing can then be reused as raw materials for the production of the same. This means that the upper/lower girt of the sports equipment can either be completely reused, broken down into its components (matrix and fiber) or completely recycled.

### Further Details on Variants of Execution and Material Classes

### Separation

By using special acid-labile or switchable thermolabile hardeners to cross-link the resins, the composite parts, using either an acidic aqueous solution (5-25% ethyl acetate solution) or, in the case of interchangeable thermolabile resin systems, with low heat input of 40 to 80° C. and/or solvents containing imine or triethylenetriamine (share of imine or triethylenetriamine of 10 to 50% by volume), are separated and completely freed from the adhesion promoter (adhesive layer), which can be reused after subsequent processing.

### Adhesion Promoter Composition

Bio-based resins from the class of epoxy resins with or without BPA, the class of unsaturated polyester resins and the class of polyacrylate resins in conjunction with acid-labile diamine-acetal and diamine-ketal-based or thermolabile polyimine-based hardeners are used as the binder matrix for the adhesion promoters according to the disclosure.

In addition to the binder matrix components mentioned, the adhesives according to the disclosure can contain additives in shares by weight of 0.1 to 40, which have the purpose of making the binder matrix conductive, which may enable inductive heating. These include, for example, carbon fiber residues from the production of carbon fiber fabrics, carbon fiber mats, carbon fiber composites, recycling processes of carbon fiber composites, by-products from the processing of carbon fibers as well as carbon fiber semi-finished products and carbon fiber composites, carbon fiber powder, carbon nanotubes, graphite powder and graphite fibers as well as various other carbon fiber modifications, which come either from recycling processes or from waste streams from the carbon fiber composites industry. Depending on the fiber length, particle size or raw material shape, it may be necessary to prepare the carbon fiber-based additives using grinding and shredding processes so that they can be mixed homogeneously with the adhesion promoter. The incorporation of these additives causes the adhesion promoter to become conductive and can be heated by induction or electromagnetic radiation. After appropriate preparation and comminution, the additives are incorporated homogeneously by mixing either into both or one of the separate adhesion promoter components or into the mixture consisting of both components.

### Application Details

In order to achieve separability of the material layers, at least 3 mm thick layers of the adhesion promoter (epoxy) are applied to one or both surfaces of the material layers to be connected. In some cases this must be prepared, i.e., the required components (resin, hardener, additives, etc.) must be mixed together in advance. In order to achieve the appropriate layer thickness, it may also be necessary to first allow each applied layer to harden sufficiently so that another layer of the same adhesion promoter can be applied. The curing process can possibly be accelerated by adding additional heat. After the adhesion promoter has been applied, the material layers are connected to one another, i.e., brought into contact with one another, depending on the process of use, and if necessary heated again to temperatures between 60° C. and a maximum of 80° C. if faster crosslinking of the resin components is desired. The actual temperature or time required for the resin matrix to fully harden depends on the resin system selected in the individual case. A modification of this process is the introduction of the water-soluble film with the help of the adhesion promoter between the material layers to be connected. The film serves, so to speak, as an additional separating layer that bonds the two layers of material together through the adhesive effect of the adhesion promoter. For this purpose, the adhesion promoter is applied as a thin layer of 0.1-1 mm both to the substrates (components to be bonded) and to the film, and all layers are connected to one another.

Both the adhesion promoter and the film have no or minimal influence on the chemical, physical and mechanical properties of the layers, so that the mechanical, physical and chemical properties of the composite structure change minimally or not at all. In addition, the material properties (chemical composition, mechanical properties) of the different layers are modified only minimally or not at all even after separation, so that the separated materials can either be recycled as single materials, reprocessed or reused in the same condition.

The application of the adhesion promoter and the connection of the material layers can take place before the actual processing of the part or directly in the actual processing or connection process of the material layers to form a finished component. Care must be taken to ensure that an increased processing temperature does not lead to accelerated hardening of the adhesion promoter layer on one of the material layers before it is brought into contact with the second layer to be connected.

### Composite Parts:

The composite parts (material layers) are, but not exclusively, multi-layer structures that contain at least one carrier material (substrate) and at least one further material as a cover layer. The materials can consist of all the same material or of different materials. The carrier material can, but does not have to, be made of metal (e.g. aluminum), a metal alloy (e.g. iron-carbon alloy), a ceramic material (e.g. various compositions of clay, feldspar, aluminum and silicon carbide, or kaolins, silicates, oxides and nitrides), a thermoplastic (PET, ABS, PP, PA, PS and their modifications) and/or thermoset polymer (e.g. epoxy, unsaturated polyester, phenol, melamine, urea or polyurethane thermosets), a foam (e.g. made of polyurethane, especially a polyurethane foam with a share of over 40% renewable raw materials, polystyrene, lignin-based materials, cellulose, PET, PP) or a combination of these materials. In addition, one of these materials can be, but does not have to be, additionally reinforced by organic and/or inorganic fibers. These include, for example, glass fibers, carbon fibers, aramid fibers, flax fibers, bamboo fibers, hemp fibers, etc. The further material layer can have, but does not have to have, either the same composition as the carrier material or any material combination of the mentioned material variations of the substrate. Often, but not necessarily, these so-called composite materials contain a symmetrical structure (a so-called sandwich structure) made of at least one substrate (lower girt), at least one core material and at least one cover layer (upper girt), wherein all layers may be made of the same material or each in itself may, but does not necessarily have to, consist of any combination of the materials mentioned.

In summary, the present disclosure relates to a recyclable composite material, consisting of at least two layers of material that are connected to one another by a layer of adhesive. In order to separate the two layers of material easily and cleanly, it is provided that the adhesive consists of a material that loses its adhesive effect placed in a weakly acidic aqueous solution.

The invention is not limited to the examples given; the materials mentioned in these examples can be combined differently, and with knowledge of the present disclosure it is easy for the person skilled in the art to find other adhesive compositions based on a few simple experiments. All temperatures stated are in degrees Celsius; unless otherwise stated, all composition details are percentages by weight.

In the description and claims, the terms “front”, “back”, “top”, “bottom” and so on are used in the generic form and with reference to the object in its usual state of use. This means that in the case of a weapon, the mouth of the barrel is “front”, that the buckle or sledge is moved “back” by the explosion gases, etc. For vehicles, “front” is the usual direction of travel. When it comes to the suspension of a monorail, and not the running rail(s), “running direction” refers to this direction on the suspension. Transverse essentially means a direction that is rotated by 90° and is essentially horizontal.

It should also be noted that in the description and claims, statements such as “lower region” of a pendant, reactor, filter, structure, or device or, more generally, of an object, mean the lower half, and in particular the lower one-quarter of the total height, “lowest region” means the lowest one-quarter and, in particular, an even smaller part; whereas “middle region” means the middle one-third of the total height (width-length). All of this information has its common meaning when applied to the intended position of the object under consideration.

In the description and claims, “substantially” means a deviation of up to 10% of the specified value, if physically possible, both downwards and upwards, otherwise only in the reasonable direction; for degrees (angle and temperature) this means±10°.

All quantities and proportions, in particular those defining the invention, as long as they do not relate to the specific examples, are to be understood as having a tolerance of ±10%, so for example: 11% means: from 9.9% to 12.1%. For designations such as: “a solvent”, the word “a” shall not be regarded as a numerical word but as an indeterminate article or an advocate, unless otherwise indicated in the context.

The term “combination” or “combinations,” if not otherwise specified, means all types of combinations, starting from two of the components concerned up to a large number or all of such components; the term “containing” also means “consisting of.”

The features and variants specified in the individual embodiments and examples can be freely combined with those of the other examples and embodiments and can be used in particular to characterize the invention in the claims without necessarily also including the other details of the respective embodiment or example

1. A composite material, comprising:
at least two layers of material connected to one another by a layer of an adhesive;
wherein the adhesive comprises a material that loses its adhesive effect when the material is placed in a weakly acidic aqueous solution.

2. The composite material according to claim 1, wherein the adhesive further comprises a material that loses its adhesive effect when heated to temperatures between 40° C. and 80° C.

3. The composite material according to claim 1, wherein the adhesive includes a BPA-free glycerol-based 2K bio-epoxy resin with an acid-labile recyclable hardener.

4. The composite material according to claim 1, wherein the adhesive includes a BPA-based 2K bio-epoxy resin system with an acid-labile recyclable hardener.

5. The composite material according to claim 1, wherein the adhesive includes a BPA-based 2K bio-epoxy resin with an acid-labile recyclable hardener.

6. The composite material according to claim 1, wherein the adhesive includes a BPA-based bio-epoxy resin component and a thermolabile polyimine hardener component.

7-11. (canceled)

12. The composite material according to claim 1, wherein the composite material includes a share of regenerative and bio-based raw materials in the layer of the adhesive that is at least 24% by weight, when measured according to ASTM D6866 based on a share of carbon from renewable sources in a molecular structure of the layer of the adhesive.

13. The composite material according to claim 12, wherein the regenerative and bio-based raw materials are derived from epoxidized vegetable oils or epoxidized sorbitol and glycerol derivatives.

14. The composite material according to claim 13, wherein the regenerative and bio-based raw materials are derived from epoxidized soybean oil, epoxidized castor oil, epoxidized linseed oil, or epoxidized cashew nut shell oil.

15. The composite material according to claim 1, wherein the composite material is recyclable.

16. The composite material according to claim 15, wherein each component of the composite material except for the adhesive layer can be recycled or reused as a single material.

17. The composite material according to claim 1, wherein at least one of the at least two layers of material is a wood, a glass, a ceramic, a natural stone, a polymer, a fiber fabric or a composite thereof, or a metal.

18. The composite material according to claim 17, wherein at least one of the at least two layers of material is a glass pane, a glass composite, or a glass plate.

19. The composite material according to claim 17, wherein at least one of the at least two layers of material is a ceramic tile, a ceramic plate, or a ceramic composite.

20. The composite material according to claim 17, wherein at least one of the at least two layers of material is a natural stone slab, a natural stone composite, or a natural stone tile.

21. The composite material according to claim 17, wherein at least one of the at least two layers of material is a thermoplastic polymer or a thermoset polymer.

22. The composite material according to claim 17, wherein the polymer includes at least one of a PP, a PET, a PLA, a PA, a PU, an ABS, a polyester, or an epoxy.

23. The composite material according to claim 17, wherein the at least one of the at least two layers of material is a fiber-filled polymer, a polymer plate, a polymer film, a polymer layer, or a roll goods.

24. The composite material according to claim 17, wherein at least one of the at least two layers of material is aluminum.

25. A method for releasing a bond of a composite material, the composite material having at least two layers of material connected to one another by a layer of an adhesive material that loses its adhesive effect when the adhesive material is placed in a weakly acidic aqueous solution; the method comprising:
preparing a weakly acidic aqueous ethyl acetate solution; and
holding the composite material in the weakly acidic aqueous ethyl acetate solution for 12-48 hours.

26. The method of claim 25, wherein preparing the weakly acidic aqueous ethyl acetate solution includes preparing an aqueous solution that is 25% by volume ethyl acetate.

27. The method of claim 25, wherein preparing the weakly acidic aqueous ethyl acetate solution further comprises adding 30-50% tetraethylenediamine by volume.

28. The method of claim 25, further comprising heating the composite material to over 40° C.

29. The method of claim 25, further comprising heating the composite material to between 40° C.-80° C.
